(19) United States
(12) Patent Application Publication
(10) Pub. No.: US 2017/0133732 A1
(43) Pub. Date: May 11, 2017

(54) APPARATUS AND METHOD FOR MANUFACTURING METAL-AIR BATTERY HAVING FOLDED STRUCTURE

(71) Applicant: Samsung Electronics Co., Ltd., Suwon-si (KR)

(72) Inventors: Joonhee Kim, Suwon-si (KR); Kyounghwan Choi, Suwon-si (KR); Jungock Park, Suwon-si (KR); Taeyoung Kim, Suwon-si (KR); Dongjoon Lee, Suwon-si (KR)

(21) Appl. No.: 15/153,834

(22) Filed: May 13, 2016

(30) Foreign Application Priority Data
Nov. 6, 2015 (KR) 10-2015-0155669

(51) Int. Cl. H01M 12/08

(52) U.S. Cl. CPC H01M 12/08

(57) ABSTRACT

An apparatus for manufacturing a metal-air battery includes a folding plate which supports a separator, an anode plate and a cathode plate during folding and stacking of the separator, the anode plate and the cathode plate to be joined to one another, a gas diffusion layer transport unit which provide a gas diffusion layer onto the folding plate, first fixing blades which presses and fixes the anode plate, the cathode plate or the gas diffusion layer, a second fixing blade which presses and fixes the anode plate, a supply unit which supplies the separator, anode plate and cathode plate to the folding plate, and a stage which moves the folding plate, the first fixing blade and the second fixing blade with respect to the supply unit.

### CROSS-REFERENCE TO RELATED APPLICATION

This application claims priority to Korean Patent Application No. 10-2015-0155669, filed on Nov. 6, 2015, and all the benefits accruing therefrom under 35 U.S.C. §119, the content of which in its entirety is herein incorporated by reference.

### BACKGROUND

1. Field

The disclosure relates to a method and an apparatus for manufacturing a metal-air battery having a folded structure, and more particularly, to an apparatus and a method for manufacturing a metal-air battery having a folded structure with improved energy density and air supply.

2. Description of the Related Art

A metal-air battery typically includes an anode that absorbs and/or emits ions and a cathode that uses oxygen in the air as an active material. Reduction and/or oxidation reactions of oxygen flowing from outside occur at the cathode and oxidation and/or reduction reactions of metal occur at the anode, and thus, chemical energy generated in the oxidation and/or reduction reactions of the metal is transformed into electrical energy. For example, the metal-air battery absorbs oxygen during discharging and emits oxygen during charging. Since the metal-air battery uses oxygen existing in the air as described above, an energy density of the metal-air battery may be rapidly improved. For example, the metal-air battery may have an energy density several times higher than an energy density of an existing lithium ion battery.

The metal-air battery may have a low ignition possibility due to an abnormal high temperature and thus has high stability. In addition, the metal-air battery operates only through absorption and/or an emission of oxygen without using heavy metals and thus has a low possibility of causing environmental pollution. Due to the various desired features described above, a lot of studies on metal-air batteries have been recently made.

### SUMMARY

Embodiments of the invention relate to a method and apparatus for manufacturing a metal-air battery having a folded structure with improved energy density and air supply.

According to an exemplary embodiment, an apparatus for manufacturing a metal-air battery, includes: a folding plate which supports a separator, an anode plate and a cathode plate during folding and stacking of the separator, the anode plate and the cathode plate to be joined to one another; a gas diffusion layer transport unit which provides a gas diffusion layer onto the folding plate; first fixing blades disposed on both sides of the folding plate and which presses and fixes the anode plate, the cathode plate or the gas diffusion layer; a second fixing blade dispose in rear of the folding plate and which presses and fixes the anode plate; a supply unit which supplies the separator, the anode plate and the cathode plate to the folding plate; and a stage which moves the folding plate, the first fixing blades and the second fixing blade with respect to the supply unit.

In an exemplary embodiment, the apparatus may further include: a first actuator which actuates the first fixing blade; and a second actuator which actuates the second fixing blade. In such an embodiment, the first actuator may move the first fixing blade in a side direction of the folding plate, and the second actuator may move the second fixing blade in front and back directions of the folding plate.

In an exemplary embodiment, the stage may move the folding plate between a first location of an area in front of the supply unit and a second location of an area behind the supply unit.

In an exemplary embodiment, when the folding plate is located in the first location, the first fixing blade may press and fix opposing side portions of the anode plate, the cathode plate or the gas diffusion layer.

In an exemplary embodiment, when the folding plate is located in the first location, the gas diffusion layer transport unit may supply the gas diffusion layer onto the folding plate.

In an exemplary embodiment, when the folding plate is located in the second location, the second fixing blade may press and fix a central portion of the anode plate.

In an exemplary embodiment, at an initial state, the stage may locate the folding plate in the first location of the area in front of the supply unit and move the folding plate forward, the first fixing blades may press and fix opposing side portions of the cathode plate, the second fixing blade may be separated from the folding plate, and the gas diffusion transport unit may transport the gas diffusion layer onto the cathode plate.

In an exemplary embodiment, at a subsequent state, the first fixing blades may retreat from the folding plate and move toward the folding plate to press and fix both sides of the gas diffusion layer, and the gas diffusion layer transport unit may rise and be separated from the gas diffusion layer.

In an exemplary embodiment, at the subsequent state, the stage may move in a back direction to locate the folding plate in the second location of the area located behind the supply unit s to fold the separator, the anode plate and the cathode plate based on a rear edge of the first fixing blade, the second fixing blade may be press and fix a central portion of the folded anode plate, and the first fixing blades may retreat from the folding plate and move toward the folding plate to press and fix opposing side portions of the folded anode plate.

In an exemplary embodiment, at the subsequent state, the second fixing blade may retreat from the folding plate and be completely separated from the folded anode plate, and the stage may locate the folding plate in the first location of the area located in front of the supply unit and move forward.

In an exemplary embodiment, the supply unit may include first and second rollers engaged with each other.

In an exemplary embodiment, the separator coated with the cathode plate and the anode plate separately manufactured from the separator may be provided to the supply unit, and the supply unit may join the separator and the anode plate when the separator, the anode plate and the cathode plate are supplied to the folding plate.

In an exemplary embodiment, the separator and the anode plate and the cathode plate which are respectively pre-joined on an upper surface and a lower surface of the separator may be provided to the supply unit.

In an exemplary embodiment, the separator may include an electrolyte which transfers metal ions from the anode plate to the cathode plate.

In an exemplary embodiment, the gas diffusion layer may be inserted in a predetermined direction of the metal-air battery having a folded structure manufactured by the apparatus.

According to another exemplary embodiment, an apparatus for manufacturing a metal-air battery, includes: a folding plate which supports a separator and an anode plate during folding and stacking of the separator and the anode plate to be joined together; a gas diffusion layer transport unit which provides a gas diffusion layer onto the folding plate; first fixing blades respectively disposed on opposing sides of the folding plate and which presses and fixes the anode plate, a cathode plate or the gas diffusion layer; a second fixing blade which is disposed in rear of the folding plate, and presses and fixes the anode plate; a supply unit which supplies the separator, the anode plate and the cathode plate to the folding plate; and a stage which moves the folding plate, the first fixing blades, and the second fixing blade with respect to the supply unit. In such an embodiment, the cathode plate may be pre-joined on an upper surface and a lower surface of the gas diffusion layer.

According to another exemplary embodiment, a method of manufacturing a metal-air battery, includes: disposing a folding plate in a first location of an area located in front of a supply unit; providing the separator, anode plate and cathode plate from the supply unit to the folding plate to be joined together; pressing and fixing opposing side portions of the cathode plate through a first fixing blade; transporting a gas diffusion layer onto the cathode plate through a gas diffusion layer transport unit; pressing and fixing opposing side portions of the gas diffusion layer through the first fixing blade; moving the folding plate into a second location of an area located behind the supply unit to fold the separator, the anode plate and the cathode plate based on a rear edge of the first fixing blade; pressing and fixing a central portion of the folded anode plate through a second fixing blade; and pressing and fixing opposing side portions of the folded anode plate through the first fixing blade.

In an exemplary embodiment, the method may further include: completely separating the second fixing blade from the folded anode plate; moving the folding plate into a first location of an area located in front of the supply unit to fold the separator, the anode plate and the cathode plate based on a front edge of the first fixing blade; transporting a gas diffusion layer onto the cathode plate through a gas diffusion layer transport unit; and pressing and fixing opposing side portions of the gas diffusion layer through the first fixing blade.

In an exemplary embodiment, the providing the separator, anode plate and cathode plate to the folding plate through the supply unit may include: providing the supply unit with the separator coated with the cathode plate and a anode plate manufactured separately from the separator; and when supplying the separator, the anode plate, and the cathode plate to the folding plate, joining the separator and the anode plate through the supply unit.

In an exemplary embodiment, the providing the separator, anode plate and cathode plate to the folding plate through the supply unit may include: providing the separator, and the anode plate and the cathode plate, which are pre-joined on an upper surface and a lower surface of the separator, to the folding plate.

### BRIEF DESCRIPTION OF THE DRAWINGS

These and/or other features will become apparent and more readily appreciated from the following description of the exemplary embodiments, taken in conjunction with the accompanying drawings, in which:

FIG. 1 is a schematic perspective view of a metal-air battery having a folded structure according to an embodiment;

FIGS. 2 through 15 are schematic cross-sectional views illustrating an apparatus and a method for manufacturing a metal-air battery of FIG. 1, according to an embodiment;

FIG. 16 is a schematic cross-sectional view illustrating an apparatus and a method for manufacturing a metal-air battery, according to an alternative embodiment;

FIG. 17 is a schematic perspective view of a metal-air battery having a folded structure, according to another alternative embodiment; and

FIG. 18 is a schematic cross-sectional view illustrating an apparatus and a method for manufacturing a metal-air battery of FIG. 17, according to an embodiment.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10%, 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Hereinafter, exemplary embodiments will be described in detail with reference to the accompanying drawings.

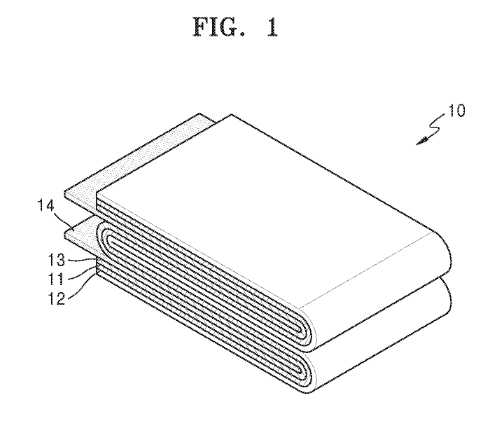

FIG. 1 is a schematic perspective view of a metal-air battery 10 having a folded structure, according to an embodiment.

Referring to FIG. 1, an embodiment of the metal-air battery 10 may include an anode plate 12, a separator 11, a cathode plate 13, and a gas diffusion layer 14. The anode plate 12 may operate to adsorb and/or emit metal ions, and the anode plate 12 may include at least one of, for example, lithium (Li), sodium (Na), zinc (Zn), potassium (K), calcium (Ca), magnesium (Mg), iron (Fe), aluminum (Al), copper (Cu), and an alloy thereof. In an embodiment, the anode plate 12 may include a plurality layers stacked one on another, where each layer may include at least one of, for example, lithium (Li), sodium (Na), zinc (Zn), potassium (K), calcium (Ca), magnesium (Mg), iron (Fe), aluminum (Al), copper (Cu), and an alloy thereof.

The separator 11 may be a polymer separator that prevents penetration of oxygen, may be conductive with respect to metal icons, and may be bendable. In one embodiment, for example, the separator 11 may include at least one of a felt formed of a polypropylene material, a polymer felt such as a polyphenylene sulfide material or the like and a porous film formed of an olefin resin such as polyethylene, polypropylene, or the like.

In an embodiment, the separator 11 may include an electrolyte that transfers the metal ions from the anode plate 12 to the cathode plate 13. The electrolyte may be formed by dissolving metal salt in a solvent. In an embodiment, the electrolyte may be in a solid state and includes a polymer electrolyte, an inorganic electrolyte, or a complex electrolyte formed of a combination thereof. In such an embodiment, the electrolyte may be bended for a process that will be described later. In one embodiment, for example, lithium salt, such as LiN(SO₂CF₂CF₃)₂, LiN(SO₂C₂F₅)₂, LiClO₄, LiBF₄, LiPF₆, LiSbF₆, LiAsF₆, LiCF₃SO₃, LiN(SO₂CF₃)₂, LiC(SO₂CF₃)₃, LiN(SO₃CF₃)₂, LiC₄F₉SO₃, LiAlCl₄, or lithium bis(trifluoromethanesulfonyl)imide (“LiTFSI”), may be used as the metal salt. Any material that may dissolve the lithium salt and the metal salt may be used as the solvent. The electrolyte may be attached as a separate layer onto the separator 11. Alternatively, the electrolyte may be immersed into porous pores to form the separator 11 as a single layer. In one embodiment, for example, an electrolyte that include or is formed of a mixture of polyethylene oxide (“PEO”) and LiTFSI may be immersed into porous pores of the separator 11.

The cathode plate 13 may include an electrolyte for conduction of the metal ions, a catalyst for oxidation and/or reduction of oxygen, a conductive material, and a binder. In one embodiment, for example, the electrolyte, the catalyst, the conductive material, and the binder may be mixed, and then a solvent may be added to manufacture a cathode slurry. In an embodiment, the cathode slurry may be coated and dried on the separator 11 to form the cathode plate 13. The electrolyte may include lithium salt or metal salt described above. A carbonic material, a conductive metal material, or a conductive organic material having porosity, or a mixture thereof may be used as the conductive material. In one embodiment, for example, carbon black, graphite, graphene, activated carbon, carbon fiber, carbon nanotube, or the like may be used as the carbonic material. The conductive metal material may be, for example, used in a metal powder form. Platinum (Pt), gold (Au), silver (Ag), or the like may be used as the catalyst. Alternatively, oxide, such as manganese (Mn), nickel (Ni), cobalt (Co), or the like, may be used as the catalyst. In an embodiment, polytetrafluoroethylene (“PTFE”), polypropylene, polyvinylidene fluoride (“PVDF”), polyethylene, styrene-butadiene rubber, or the like may be used as the binder.

The gas diffusion layer 14 operates to absorb oxygen in air and provide the oxygen to the cathode plate 13. In an embodiment, the gas diffusion layer 14 may have a porous structure to smoothly diffuse external oxygen. In one embodiment, for example, the gas diffusion layer 14 may be formed by using carbon paper, carbon cloth, or carbon felt using a carbon fiber, or foam metal or a metal fiber mat on sponge.

As shown in FIG. 1, the anode plate 12, the separator 11 and the cathode plate 13 are bent to enclose three sides or surfaces (e.g., upper and lower surfaces and a side surface) of the gas diffusion layer 14. In one embodiment, for example, a part of the gas diffusion layer 14 may disposed on the cathode plate 13, and then the anode plate 12, the separator 11 and the cathode plate 13 may be bent on the gas diffusion layer 14 to allow the cathode plate 13 to contact an upper surface of the gas diffusion layer 14. Thereafter, the anode plate 12, the separator 11 and the cathode plate 13 may be folded in reverse in a direction of about 180° to allow the cathode plate 13 to face upwards. In such an embodiment, the gas diffusion layer 14 may be additionally disposed on the cathode plate 13, and the anode plate 12, the separator 11 and the cathode plate 13 may be bent on the gas diffusion layer 14 to allow the cathode plate 13 to contact the upper surface of the gas diffusion layer 14. In an embodiment, as shown in FIG. 1, in the structure of the metal-air battery 10, merely the anode plate 12 may be seen on a right side of the metal-air battery 10, and the separator 11, the cathode plate 13 and the gas diffusion layer 14 may be exposed on a left side of the metal-air layer 10. In such an embodiment, the gas diffusion layer 14 may be inserted in a direction of the metal-air battery 10. Therefore, oxygen needed in oxidation and/or reduction reactions in the cathode plate 13 may be absorbed from a left side of the gas diffusion layer 14 to be supplied into a whole area of the cathode plate 13.

FIG. 1 illustrates an embodiment where the metal-air battery 10 includes two gas diffusion layers 14 for convenience of illustrating the folded structure of the metal-air battery 10. However, in an embodiment, a unit cell of the metal-air battery 10 may have a structure where the anode plate 12, the separator 11 and the cathode plate 13 enclose three sides of a single gas diffusion layer 14. Therefore, the metal-air battery 10 of FIG. 1 may be regarded as a structure including two unit cells as folded types. According to an embodiment of a method of manufacturing the metal-air battery 10 described above, a process of disposing the gas diffusion layer 14 on the cathode plate 13 and bending the anode plate 12, the separator 11 and the cathode plate 13 may be repeated to increase the number of unit cells of the metal-air battery 10.

In an embodiment of the metal-air battery 10 having the folded structure as shown in FIG. 1, a part of the gas diffusion layer 14 may be exposed to an outside at all times. In one embodiment, for example, a partial side of the gas diffusion layer 14 seen at a front of FIG. 1 is covered with an external material (not shown) when the metal-air battery 10 is packed with the external material. However, in FIG. 1, although the metal-air battery 10 is packed with the external material, a left side of the gas diffusion layer 14 may be exposed to the outside at all times. Therefore, oxygen may be easily supplied to the cathode plate 13 regardless of the increase in the number of cells of the metal-air battery 10.

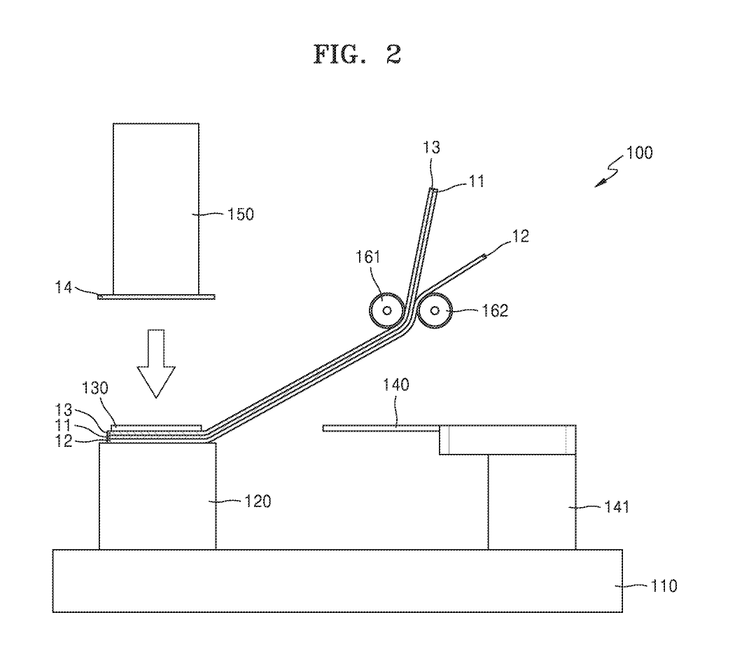

FIGS. 2 through 15 are schematic cross-sectional views illustrating an apparatus 100 and a method for manufacturing the metal-air battery 10 of FIG. 1, according to an exemplary embodiment. Hereinafter, the apparatus 100 and the method for manufacturing the metal-air battery 10 according to an exemplary embodiment will be described in detail with reference to FIGS. 2 through 15.

Referring to FIG. 2, an embodiment of the apparatus 100 for manufacturing the metal-air battery 10 may include: a folding plate 120 that operates as a support for folding and stacking the separator 11, the anode plate 12 and the cathode plate 13 that are joined together; a supply unit 161 and 162 that joins the separator 11, the anode plate 12 and the cathode plate 13 together and supply the separator 11, the anode plate 12 and the cathode plate 13 to the folding plate 120; a first fixing blade 130 that fixes the cathode plate 13 so as not to loosen the cathode plate 13 when folding and stacking the separator 11, the anode plate 12 and the cathode plate 13; a second fixing blade 14 that fixes the anode plate 12 so as not loosen the anode plate 12 when folding and stacking the separator 11, the anode plate 12 and the cathode plate 13; a gas diffusion layer transport unit 150 that provides the gas diffusion layer 14 onto the cathode plate 13; and a stage 110 on which the folding plate 120, the first fixing blade 130 and the second fixing blade 14 are disposed.

In an embodiment, the stage 110 may support the folding plate 120, the first fixing blade 130 and the second fixing blade 140, and move relatively with respect to the supply unit 161 and 162. In such an embodiment, the apparatus 100 may further include a first actuator that actuates the first fixing blade 130, and a second actuator 141 that actuates the second fixing blade 140. The supply unit 161 and 162 may, for example, include a first roller 161 and a second roller 162 that engage with each other to rotate.

In an embodiment, at an initial stage, the stage 110 may move forward to locate the folding plate 120 in an area located in front of the supply unit 161 and 162. In such an embodiment, ends of the separator 11, the anode plate 12 and the cathode plate 13 that are supplied through the supply unit 161 and 162 may be disposed on the folding plate 120, and the cathode plate 13 may be pressed downwardly by the first fixing blade 130 to fix the separator 11, the anode plate 12 and the cathode plate 13 to each other. In an embodiment, the cathode plate 13 may be pre-jointed on an upper surface of the separator 11, and the anode plate 12 may be provided to the supply unit 161 and 162 separately from the separator 11. When the separator 11 and the anode plate 12 are provided to the folding plate 120, the anode plate 12 may be joined onto a lower surface of the separator 11 by the supply unit 161 and 162. As shown in FIG. 2, the second fixing blade 140 may stay away from the folding plate 120 at the initial stage.

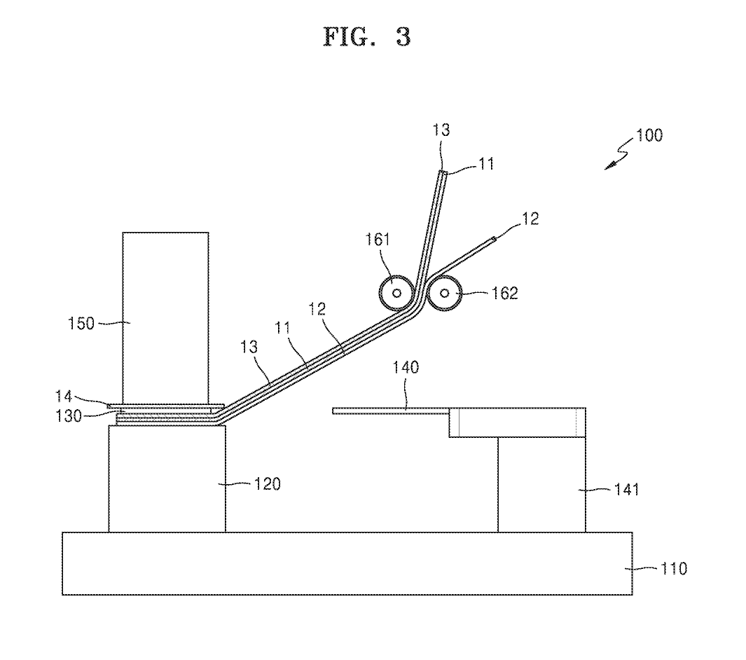

Referring to FIG. 3, the gas diffusion layer transport unit 150 move the gas diffusion layer 14 to be disposed on the cathode plate 13. In one embodiment, for example, the gas diffusion layer 14 may be loaded on an additional loading unit (not shown), and the gas diffusion layer transport unit 150 may lift one of the gas diffusion layers 14 loaded in the additional loading unit using an air suction method to transport the one gas diffusion layer 14 to the cathode plate 13. In such an embodiment, a part of the gas diffusion layer 14 is located above the first fixing blade 130.

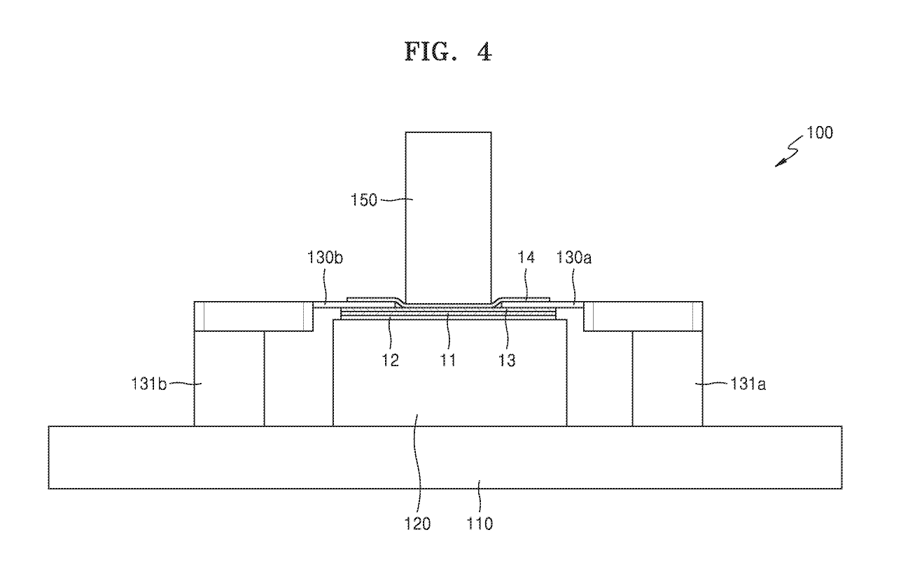

FIG. 4 is a front cross-sectional view shown in a different direction from a side cross-sectional view of FIG. 3. Referring to FIG. 4, two first fixing blades 130a and 130b press and fix opposing side portions of the cathode plate 13, and the gas diffusion layer transport unit 150 is located between the two first fixing blades 130a and 130b. In such an embodiment, a central portion of the gas diffusion layer 14 contacts an upper surface of the cathode plate 13, and opposing side portions of the gas diffusion layer 14 are respectively located on the two first fixing blades 130a and 130b.

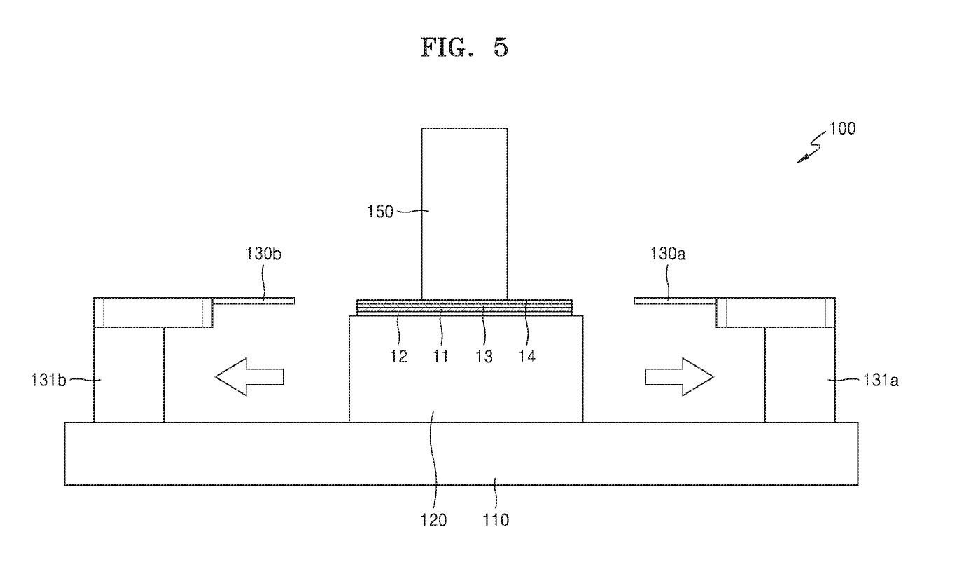

Referring to a front cross-sectional view of FIG. 5, when the gas diffusion layer transport unit 150 presses the gas diffusion layer 14 to fix the gas diffusion layer 14 on the cathode plate 13, the two first fixing blades 130a and 130b may respectively retreat from the folding plate 120 in opposing directions, e.g., left and right directions. In such an embodiment, two first actuators 131a and 131b may respectively move the first fixing blades 130a and 130b. In one embodiment, for example, the first actuators 131a and 131b may move the first fixing blades 130a and 130b in left and right directions until the first fixing blades 130a and 130b are completely or effectively separated from the cathode plate 13.

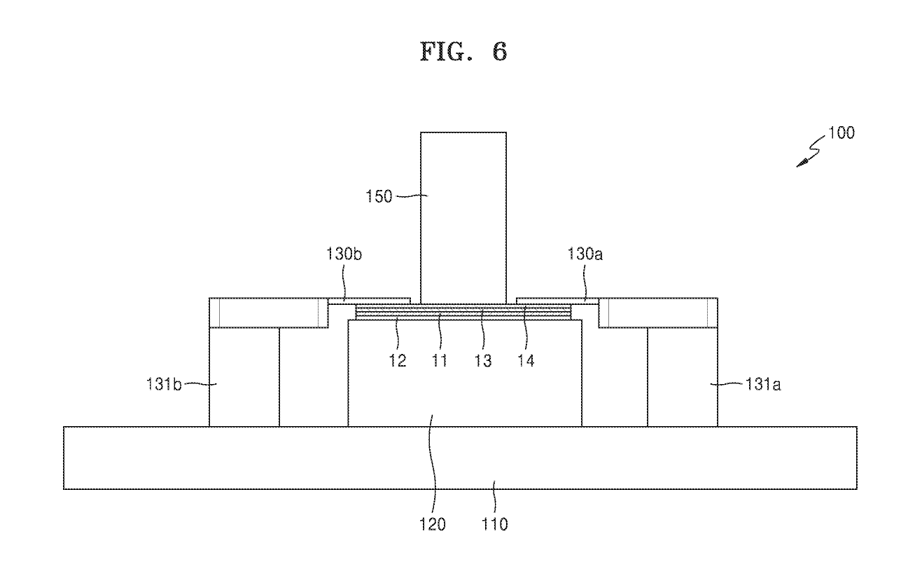

Referring to a front cross-sectional view of FIG. 6, the first actuators 131a and 131b respectively slightly raise the first fixing blades 130a and 130b and then moves the first fixing blades 130a and 130b toward the folding plate 120. Then, the first actuators 131a and 131b move the first fixing blades 130a and 130b to descend and the first fixing blades 130a and 130b press the gas diffusion layer 14. In such an embodiment, opposing side portions of the gas diffusion layer 14 may be respectively pressed by the first fixing blades 130a and 130b to fix the gas diffusion layer 14 on the cathode plate 13.

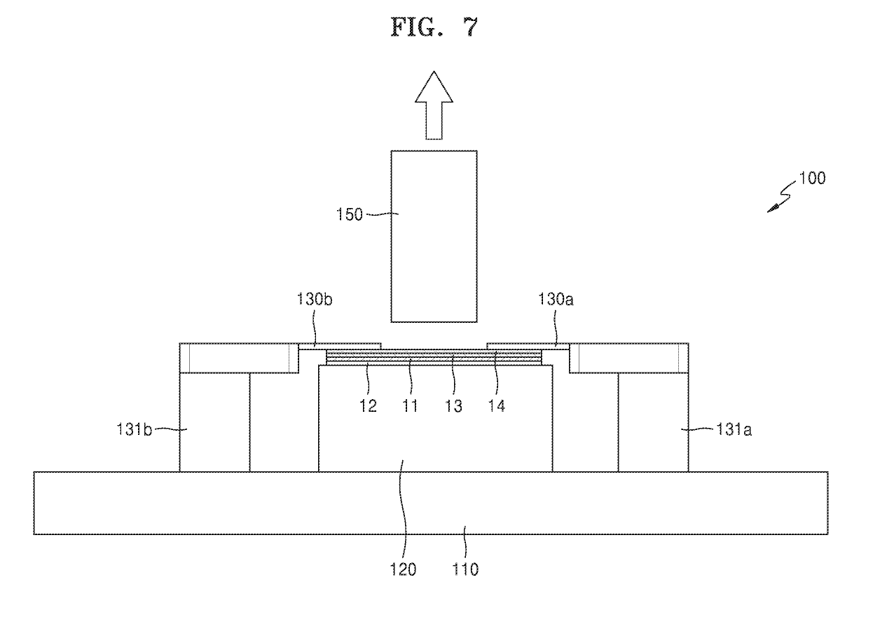

When the gas diffusion layer 14 is completely or effectively fixed by the first fixing blades 130a and 130b, the gas diffusion layer transport unit 150 rises upwards to be separated from the gas diffusion layer 14 as shown in a front cross-sectional view of FIG. 7. Although not shown, the gas diffusion layer transport unit 150 may move to a loading unit where a plurality of gas diffusion layers 14 is loaded.

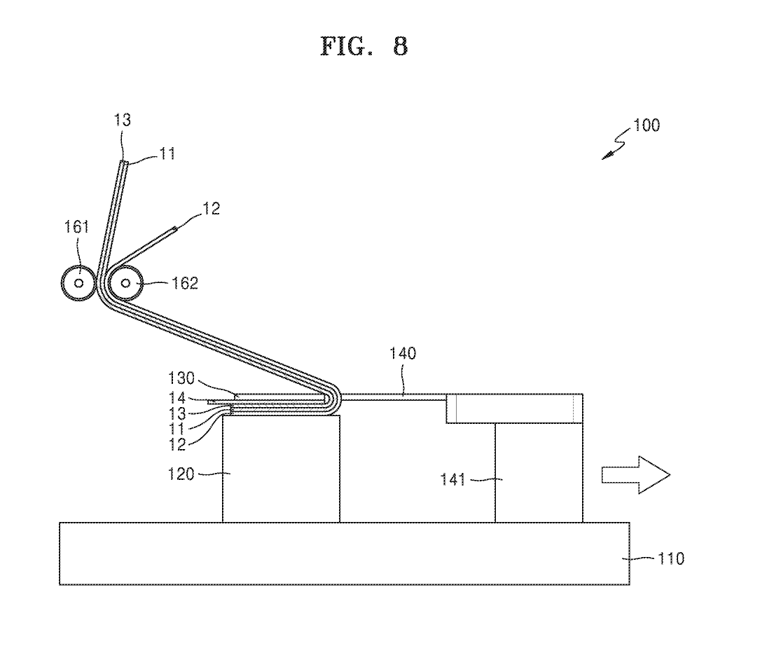

Referring to a side cross-sectional view of FIG. 8, the stage 110 may move backward to locate the folding plate 120 in an area located in rear of the supply unit 161 and 612. The folding plate 120, the first fixing blade 130 and the second fixing blade 140, which are disposed on the stage 110, move backward with the movement of the stage 110 backward. The separator 11, the anode plate 12 and the cathode plate 13 that are supplied through the supply unit 161 and 162 are folded based on a rear edge of the first fixing blade 130. However, the separator 11, the anode plate 12 and the cathode plate 13 may not be completely folded at about 180°. In one embodiment, for example, the stage 110 may move backward until the separator 11, the anode plate 12 and the cathode plate 13 are folded at an angle in a range between about 120° and about 160°.

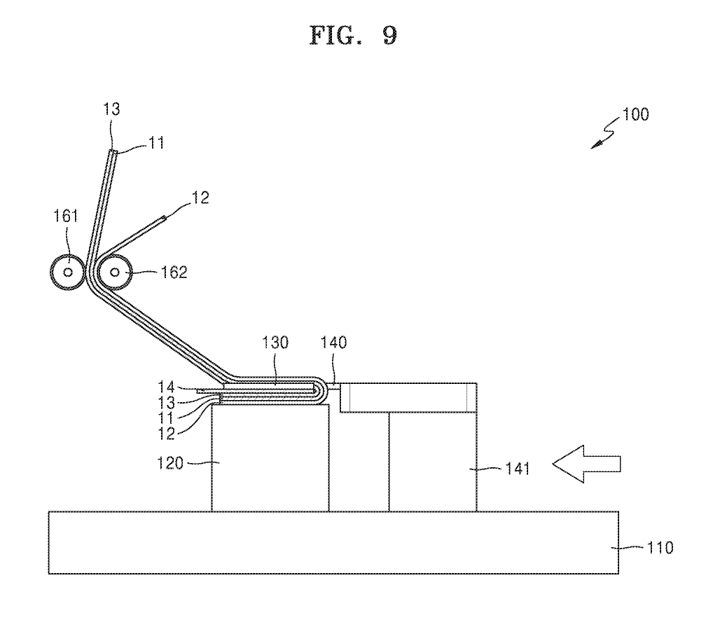

Referring to a side cross-sectional view of FIG. 9, in such an embodiment, a second actuator 141 slightly raises the second fixing blade 140 and then moves the second fixing blade 140 toward the folding plate 120. In such an embodiment, as the anode plate 12 is moved backward by the second fixing blade 140, the separator 11, the anode plate 12 and the cathode plate 13 are folded at an angle of about 180°. When the second fixing blade 140 arrives on the folding plate 120, the second actuator 141 moves the second fixing blade 140 to descend to press and fix the anode plate 12. Accordingly, the separator 11, the anode plate 12 and the cathode plate 13 may be completely folded at an angle of about 180°.

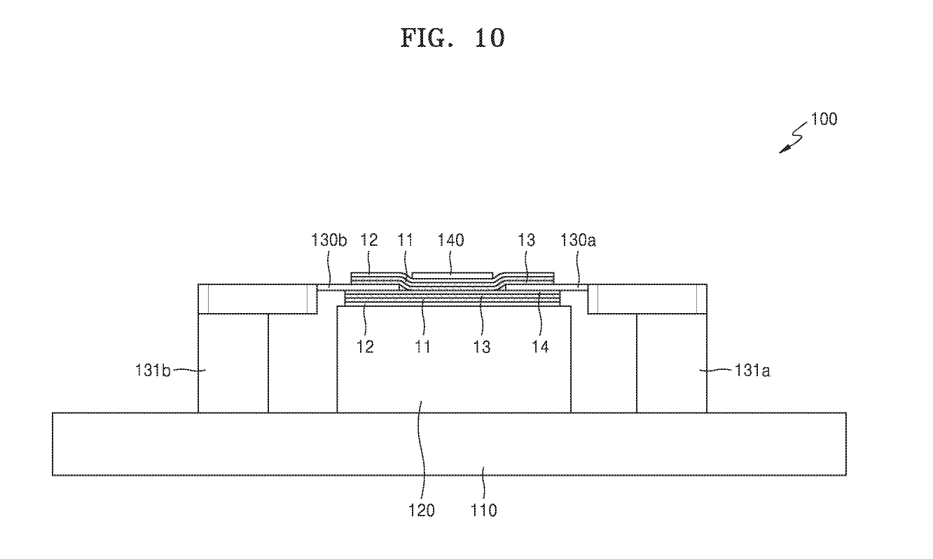

FIG. 10 is a front cross-sectional view shown in a different direction from the side cross-sectional view of FIG. 9. Referring to FIG. 10, the two first fixing blades 130a and 130b respectively press and fixe opposing side portions of the gas diffusion layer 14, and the second fixing blade 140 is located between the two first fixing blades 130a and 130b. In such an embodiment, central portions of folded parts of the separator 11, the anode plate 12 and the cathode plate 13 contact an upper surface of the gas diffusion layer 140. In such an embodiment, the central part of the folded part of the cathode plate 13 directly contacts the upper surface of the gas diffusion layer 14. Opposing side portions of the folded parts of the separator 11, the anode plate 12 and the cathode plate 13 are respectively located on the two first fixing blades 130a and 130b.

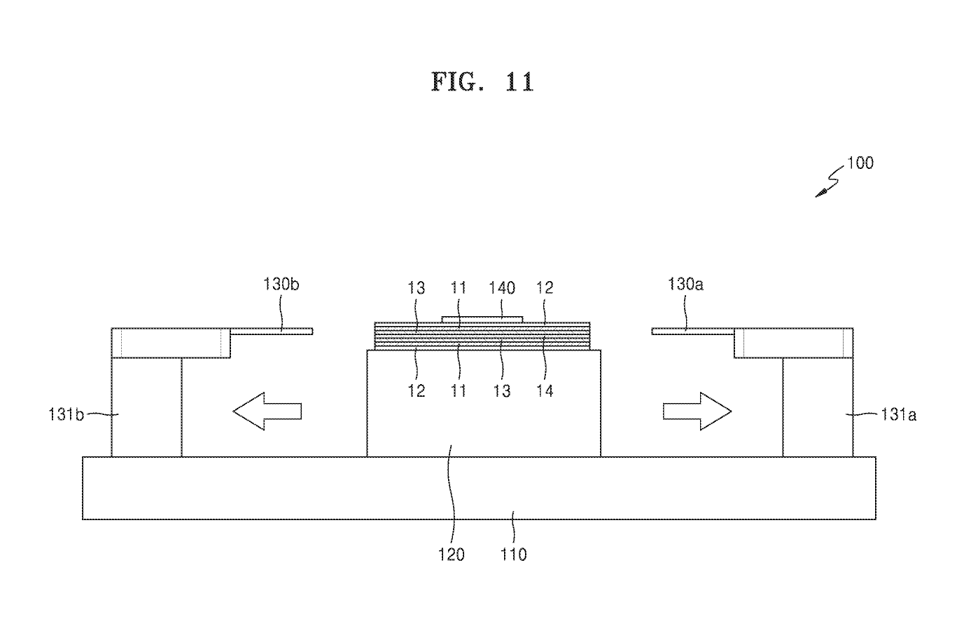

Referring to a front cross-sectional view of FIG. 11, while the second fixing blade 140 presses and fixes the folded anode plate 12, the two first fixing blades 130a and 130b may respectively retreat from the folding plate 120 to the left and right sides. In such an embodiment, the two first actuators 131a and 131b may respectively move the first fixing blades 130a and 130b in opposing directions to allow the two first fixing blades 130a and 130b to retreat from the folding plate 120. In one embodiment, for example, the first actuators 131a and 131b may move the first fixing blades 130a and 130b in left and right directions until the first fixing blades 130a and 130b are completely or effectively separated from the gas diffusion layer 14.

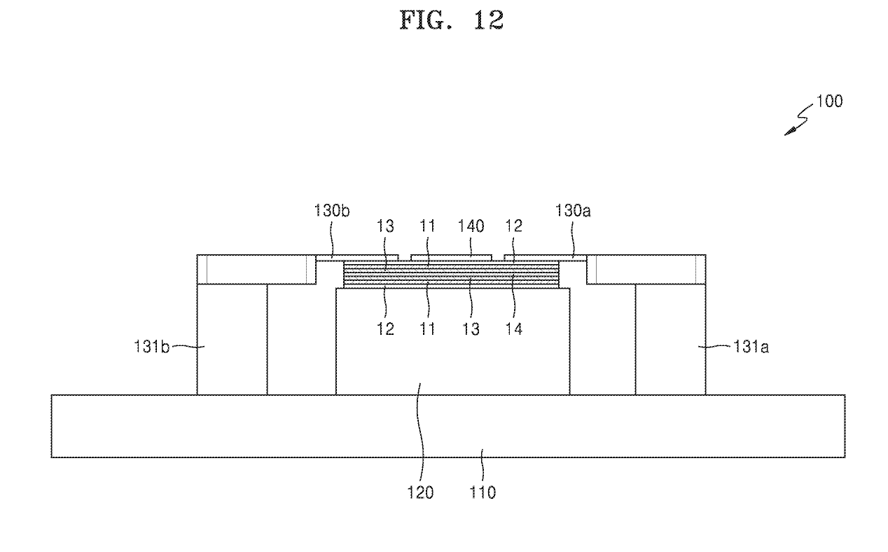

Referring to a front cross-sectional view of FIG. 12, the first actuators 131a and 131b slightly raise the first fixing blades 130a and 130b and then moves the first fixing blades 130a and 130b inward toward the folding plate 120. Then, the first actuators 131a and 131b move the first fixing blades 130a and 130b to descend, and the first fixing blades 130a and 130b press the folded anode plate 12. In such an embodiment, opposing side portions of the folded anode plate 12 may be pressed by the first fixing blades 130a and 130b to completely or effectively fix the folded parts of the separator 11, the anode plate 1, and the cathode plate 13 on the gas diffusion layer 14 disposed thereunder.

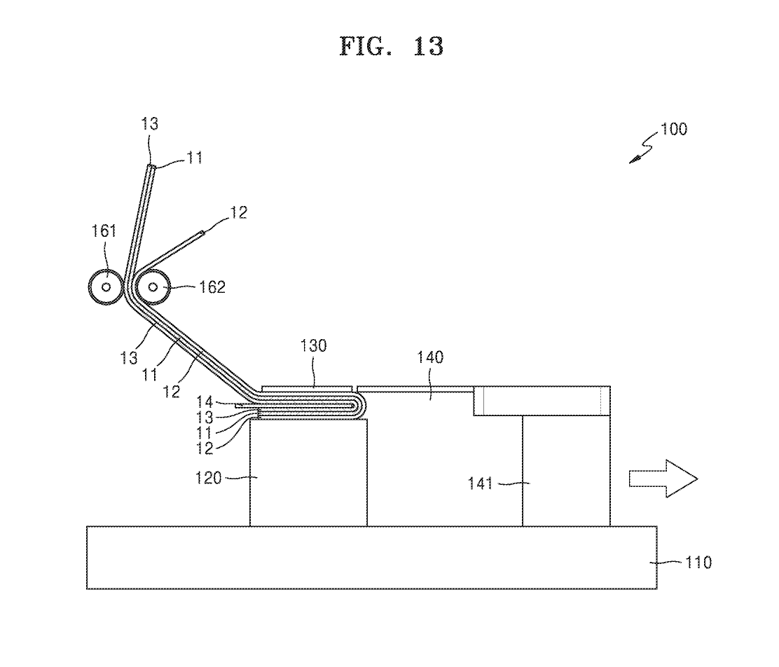

Referring to a side cross-sectional view of FIG. 13, the second fixing blade 140 retreats from the folding plate 120 to be completely or effectively separated from the anode plate 12. As shown in FIGS. 9 through 13, two first fixing blades 130 may be disposed on opposing side portions of the folding plate 120 to move toward a side of the folding plate 120 to press and fix opposing side portions of the cathode plate 13, the gas diffusion layer 14 or the anode plate 13. The second fixing blade may be disposed in the rear of the folding plate 120 and may move in front and back directions of the folding plate 120 perpendicular to a movement direction of the first fixing blades 130 so as to press and fix a central part of the folded anode plate 12.

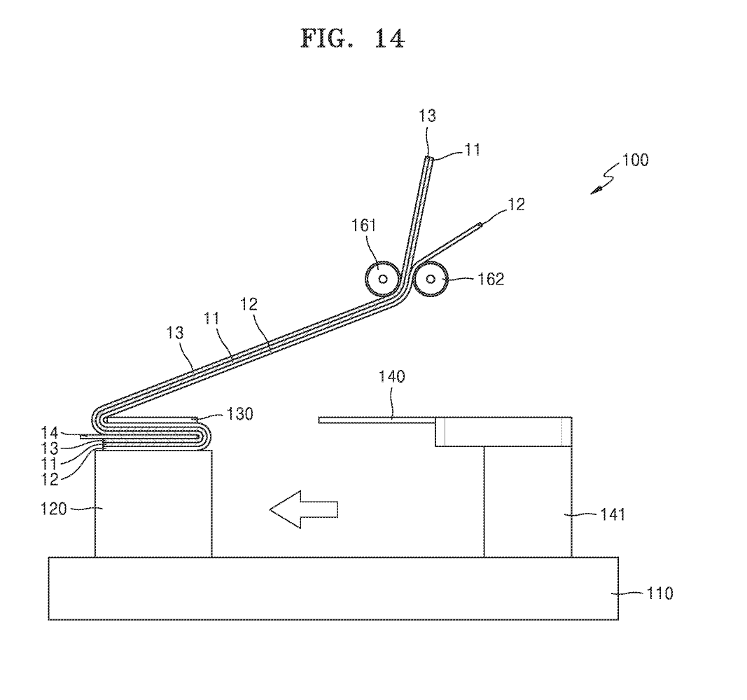

Referring to a side cross-sectional view of FIG. 14, the stage 110 may move forward to locate the folding plate 120 in an area located in front of the supply unit 161 and 162. The stage 110 moves forward to move the folding plate 120, the first fixing blade 130 and the second fixing blade 140, which are disposed on the stage 110, forward. In such an embodiment, the separator 11, the anode plate 12 and the cathode plate 13 that are supplied through the supply unit 161 and 162 are folded based on a front edge of the first fixing blade 130. However, the separator 11, the anode plate 12 and the cathode plate 13 may not be completely folded at about 180° by such a process. In one embodiment, for example, the stage 110 may move forward until the separator 11, the anode plate 12, and the cathode plate 13 are folded within a range between about 120° and about 160°.

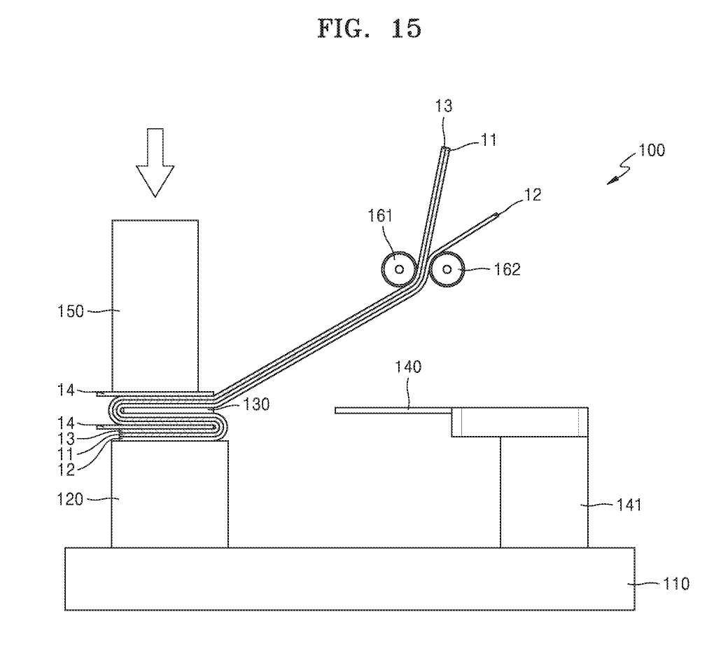

Referring to FIG. 15, the gas diffusion layer transport unit 150 disposes the gas diffusion layer 14 on the cathode plate 13. In such an embodiment, the separator 11, the anode plate 12 and the cathode plate 13 may be pressed by the gas diffusion layer transport unit 150 to be completely folded at about 180°. Until the number of times the metal-air battery 10 being stacked reaches a desired stack number, the folding plate 120 moves back and forth between an area located in front of the supply unit 161 and 162 and an area located in the rear of the supply unit 161 and 162 to repeat the processes described above with reference to FIGS. 5 through 14.

According to exemplary embodiments of the apparatus 100 and the method for manufacturing the metal-air battery 10 described above, the anode plate 12 and the separator 11 may be repeatedly folded and stacked to efficiently insert the cathode plate 13 and the gas diffusion layer 14 between folded parts of the separator 11. Therefore, the metal-air battery 10 having the folded structure may be efficiently manufactured in quantity.

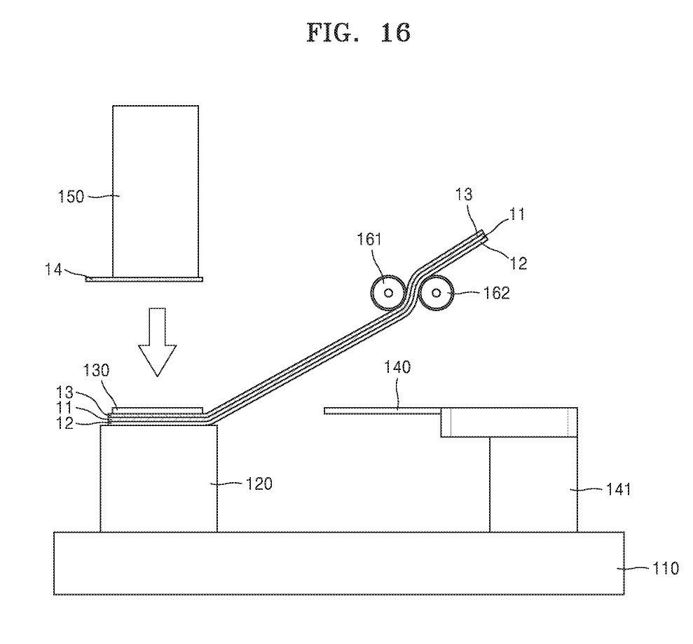

As described with reference to FIGS. 2 through 15, the anode plate 12 is manufactured separately from the separator 11 coated with the cathode plate 13, and the separator 11 and the anode plate 12 are joined to the supply unit 161 and 162. In an alternative embodiment, the separator 11, the anode plate 12 and the cathode plate 13 may be pre-joined together and then supplied to the apparatus 100, as shown in FIG. 16.

FIG. 16 is a schematic cross-sectional view illustrating an apparatus and a method for manufacturing the metal-air battery 10, according to an alternative exemplary embodiment. The exemplary embodiment of FIG. 16 is substantially the same as the exemplary embodiments of FIGS. 2 through 15 except that the cathode plate 13 and the anode plate 12 are pre-joined onto an upper surface and a lower surface of the separator 11 and the separator 11, the anode plate 12 and the cathode plate 13 that are pre-joined are supplied to the apparatus through the supply unit 161 and 162. Other manufacturing processes are the same as those of FIGS. 2 through 15, and any repetitive detailed description thereof will be omitted.

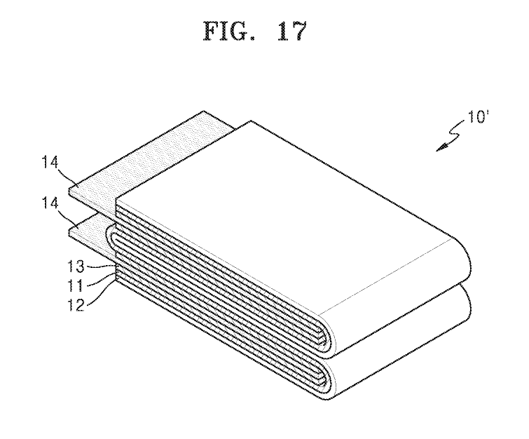

FIG. 17 is a schematic perspective view of a metal-air battery 10′ having a folded structure, according to an alternative exemplary embodiment. In an exemplary embodiment of the metal-air battery 10, as shown in FIG. 1, the separator 11, the anode plate 12 and the cathode plate 13 are repeatedly folded to insert the gas diffusion layer 14 between folded parts of the cathode plate 13. In an alternative exemplary embodiment of the metal-air battery 10′, as shown in FIG. 17, the separator 11 and the anode plate 12 are repeatedly folded s to insert the cathode plate 13 and the gas diffusion layer 14 between folded parts of the separator 11. In such an embodiment, the cathode plate 13 is pre-joined onto an upper surface and a lower surface of the gas diffusion layer 14. Therefore, the cathode plate 13 that is joined onto the upper surface and the lower surface of the gas diffusion layer 14 contacts an internal surface of the folded separator 11.

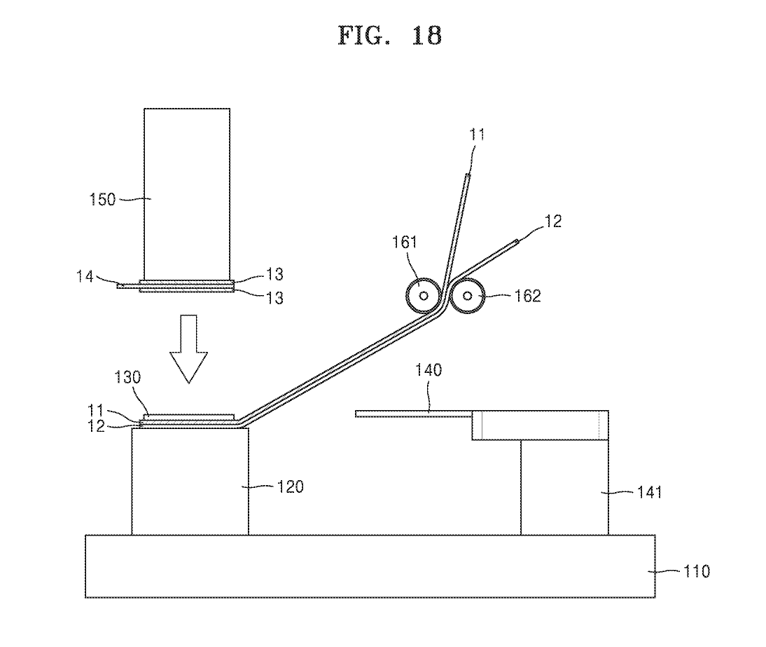

FIG. 18 is a side cross-sectional view schematically illustrating an apparatus and a method for manufacturing the metal-air battery 10′ of FIG. 17, according to an embodiment.

Referring to FIG. 18, the separator 11 and the anode plate 12 that are separately manufactured may be provided to the folding plate 120 to be joined together by the supply unit 161 and 162. Alternatively, as shown in FIG. 16, the separator 11 and the anode plate 12 that are pre-joined may be supplied through the supply unit 161 and 162. In such an embodiment, the gas diffusion layer transport unit 150 may supply the gas diffusion layer 14 having the upper and lower surfaces, onto which the anode plate 13 is pre-joined, onto the separator 11. Other processes in such an embodiment are the same as those described above with reference to FIGS. 2 through 15, and any repetitive detailed description thereof will be omitted.

While one or more embodiments have been described with reference to the figures, it will be understood by those of ordinary skill in the art that various changes in form and details may be made therein without departing from the spirit and scope of the invention as defined by the following claims.

What is claimed is:

1. An apparatus for manufacturing a metal-air battery, the apparatus comprising:
a folding plate which supports a separator, an anode plate and a cathode plate during folding and stacking of the separator, the anode plate and the cathode plate to be joined to one another;
a gas diffusion layer transport unit which provides a gas diffusion layer onto the folding plate;
first fixing blades disposed on opposing sides of the folding plate and which presses and fixes the anode plate, the cathode plate or the gas diffusion layer;
a second fixing blade dispose in rear of the folding plate and which presses and fixes the anode plate;
a supply unit which supplies the separator, the anode plate and the cathode plate to the folding plate; and
a stage which move the folding plate, the first fixing blades and the second fixing blade with respect to the supply unit.

2. The apparatus of claim 1, further comprising:
a first actuator which actuates the first fixing blade; and
a second actuator which actuates the second fixing blade,
wherein the first actuator moves the first fixing blade in a side direction of the folding plate, and
the second actuator moves the second fixing blade in front and back directions of the folding plate.

3. The apparatus of claim 1, wherein the stage moves the folding plate between a first location of an area in front of the supply unit and a second location of an area behind the supply unit.

4. The apparatus of claim 3, wherein when the folding plate is located in the first location, the first fixing blade presses and fixes opposing side portions of the anode plate, the cathode plate or the gas diffusion layer.

5. The apparatus of claim 3, wherein when the folding plate is located in the first location, the gas diffusion layer transport unit supplies the gas diffusion layer onto the folding plate.

6. The apparatus of claim 3, wherein when the folding plate is located in the second location, the second fixing blade presses and fixes a central portion of the anode plate.

7. The apparatus of claim 3, wherein
at an initial state, the stage locates the folding plate in the first location of the area in front of the supply unit and moves the folding plate forward,
at the initial state, the first fixing blades presses and fixes opposing side portions of the cathode plate,
at the initial state, the second fixing blade is separated from the folding plate, and
at the initial state, the gas diffusion transport unit transports the gas diffusion layer onto the cathode plate.

8. The apparatus of claim 7, wherein
at a subsequent state, the first fixing blades retreats from the folding plate and moves toward the folding plate to press and fix opposing side portions of the gas diffusion layer, and
at the subsequent state, the gas diffusion layer transport unit rises and is separated from the gas diffusion layer.

9. The apparatus of claim 8, wherein
at the subsequent state, the stage moves in a back direction to locate the folding plate in the second location of the area located behind the supply unit to fold the separator, the anode plate and the cathode plate based on a rear edge of the first fixing blade,
at the subsequent state, the second fixing blade presses and fixes a central portion of the folded anode plate, and
at the subsequent state, the first fixing blades retreats from the folding plate and moves toward the folding plate to press and fix opposing side portions of the folded anode plate.

10. The apparatus of claim 9, wherein
at the subsequent state, the second fixing blade retreats from the folding plate and is completely separated from the folded anode plate, and
at the subsequent state, the stage locates the folding plate in the first location of the area located in front of the supply unit and moves forward.

11. The apparatus of claim 1, wherein the supply unit comprises first and second rollers engaged with each other.

12. The apparatus of claim 1, wherein
the separator coated with the cathode plate and the anode plate, which is separated from the separator coated with the cathode plate, are provided to the supply unit, and
the supply unit joins the separator and the anode plate when the separator, the anode plate and the cathode plate are supplied to the folding plate.

13. The apparatus of claim 1, wherein the separator, and the anode plate and the cathode plate which are respectively pre-joined on an upper surface and a lower surface of the separator are provided to the supply unit.

14. The apparatus of claim 1, wherein the separator comprises an electrolyte which transfers metal ions from the anode plate to the cathode plate.

15. The apparatus of claim 1, wherein the gas diffusion layer is inserted in a predetermined direction of the metal-air battery having a folded structure manufactured by the apparatus.

16. An apparatus for manufacturing a metal-air battery, the apparatus comprising:
a folding plate which supports a separator and an anode plate during folding and stacking of the separator and the anode plate to be joined together;
a gas diffusion layer transport unit which provides a gas diffusion layer onto the folding plate;
first fixing blades respectively disposed on opposing sides of the folding plate and which presses and fixes the anode plate, a cathode plate or the gas diffusion layer;
a second fixing blade which is disposed in rear of the folding plate, and presses and fixes the anode plate;
a supply unit which supplies the separator, the anode plate and the cathode plate to the folding plate; and
a stage which move the folding plate, the first fixing blades and the second fixing blade with respect to the supply unit,
wherein the cathode plate is pre-joined on an upper surface and a lower surface of the gas diffusion layer.

17. A method of manufacturing a metal-air battery, the method comprising:
disposing a folding plate in a first location of an area located in front of a supply unit;
providing the separator, anode plate and cathode plate from the supply unit to the folding plate to be joined together;
pressing and fixing opposing side portions of the cathode plate through a first fixing blade;
transporting a gas diffusion layer onto the cathode plate through a gas diffusion layer transport unit;
pressing and fixing opposing sides of the gas diffusion layer on the cathode plate through the first fixing blade;
moving the folding plate into a second location of an area located behind the supply unit to fold the separator, the anode plate and the cathode plate based on a rear edge of the first fixing blade;
pressing and fixing a central portion of the folded anode plate through a second fixing blade; and
pressing and fixing opposing side portions of the folded anode plate through the first fixing blade.

18. The method of claim 17, further comprising:
completely separating the second fixing blade from the folded anode plate;
moving the folding plate into a first location of an area located in front of the supply unit to fold the separator, the anode plate and the cathode plate based on a front edge of the first fixing blade;
transporting a gas diffusion layer onto the cathode plate through a gas diffusion layer transport unit; and
pressing and fixing opposing side portions of the gas diffusion layer through the first fixing blade.

19. The method of claim 17, wherein the providing the separator, anode plate and cathode plate to the folding plate through the supply unit comprises:
providing the supply unit with the separator coated with the cathode plate and a anode plate manufactured separately from the separator; and
when supplying the separator, the anode plate and the cathode plate to the folding plate, joining the separator and the anode plate through the supply unit.

20. The method of claim 17, wherein the providing the separator, anode plate and cathode plate to the folding plate through the supply unit comprises:
providing the separator, and the anode plate and the cathode plate, which are pre-joined on an upper surface and a lower surface of the separator, to the folding plate.
